(19) United States
(12) Patent Application Publication
(10) Pub. No.: US 2018/0095475 A1
(43) Pub. Date: Apr. 5, 2018

(54) SYSTEMS AND METHODS FOR VISUAL POSITION ESTIMATION IN AUTONOMOUS VEHICLES

(71) Applicant: GM GLOBAL TECHNOLOGY OPERATIONS LLC, Detroit, MI (US)

(72) Inventors: Gautier Minster, San Francisco, CA (US); Clement Creusot, San Francisco, CA (US)

(73) Assignee: GM GLOBAL TECHNOLOGY OPERATIONS LLC, Detroit, MI (US)

(21) Appl. No.: 15/820,628

(22) Filed: Nov. 22, 2017

(51) Int. Cl. G05D 1/02; G06T 7/70; G06K 9/00; G06T 11/60

(52) U.S. Cl. CPC G05D 1/0246; G06T 7/70; G05D 1/0287; G06T 11/60; G06K 9/00805

(57) ABSTRACT

Systems and method are provided for controlling a vehicle. In one embodiment, a visual position estimation method includes providing a ground model of an environment, and receiving, at a vehicle, sensor data relating to the environment, the sensor data including optical image data acquired by an optical camera coupled to the vehicle. A virtual camera image is generated based on the ground model, the position of the vehicle, and a position of the optical camera. The position of an object in the environment is determined based on the virtual camera image and the optical image data.

### TECHNICAL FIELD

The present disclosure generally relates to autonomous vehicles, and more particularly relates to systems and methods for determining the spatial position of detected objects detected by an autonomous vehicle.

### BACKGROUND

An autonomous vehicle is a vehicle that is capable of sensing its environment and navigating with little or no user input. It does so by using sensing devices such as radar, lidar, image sensors, and the like. Autonomous vehicles further use information from global positioning systems (GPS) technology, navigation systems, vehicle-to-vehicle communication, vehicle-to-infrastructure technology, and/or drive-by-wire systems to navigate the vehicle.

While recent years have seen significant advancements in navigation systems, such systems might still be improved in a number of respects. For example, there is a need for efficient, fast, and accurate methods for determining the location of objects detected in the environment, such as other vehicles, construction objects, and the like.

Accordingly, it is desirable to provide systems and methods for detecting and determining the location of objects detected by autonomous vehicles. Furthermore, other desirable features and characteristics of the present invention will become apparent from the subsequent detailed description and the appended claims, taken in conjunction with the accompanying drawings and the foregoing technical field and background.

### SUMMARY

Systems and method are provided for controlling a first vehicle. In one embodiment, a visual position estimation method includes providing a ground model of an environment and receiving, at a vehicle, sensor data relating to the environment, the sensor data including optical image data acquired by an optical camera coupled to the vehicle. The method further includes generating, with a processor, a virtual camera image based on the ground model, the position of the vehicle, and a position of the optical camera; and determining, with a processor, a position of an object in the environment based on the virtual camera image and the optical image data.

In one embodiment, the ground model of the environment is provided by acquiring sensor data relating to the position of the ground via a plurality of sensor systems incorporated into a corresponding plurality of autonomous vehicles.

In one embodiment, determining the position of the object includes superimposing the virtual camera image onto the optical image data.

In one embodiment, determining the position of the object includes determining an intersection between the ground model in the virtual camera image and a geometric representation of the object.

In one embodiment, the geometric representation of the object is a bounding rectangle.

In one embodiment, the virtual camera image includes a plurality of pixels, each having a corresponding pre-computed distance from the vehicle and a point on the ground model.

In one embodiment, the ground model includes a two-dimensional array of position values in a world coordinate frame.

A system for controlling a vehicle in accordance with one embodiment includes a ground model creation module, a sensor system, a virtual camera image module, and an object position determination module. The ground model creation module, including a processor, is configured to generate a ground model of an environment. The sensor system is configured to produce sensor data relating to the environment, the sensor data including optical image data acquired by an optical camera coupled to the vehicle. The virtual camera image module, including a processor, is configured to generate a virtual camera image based on the ground model, the position of the vehicle, and a position of the optical camera. The object position determination module, including a processor, is configured to determine a position of an object in the environment based on the virtual camera image and the optical image data.

In one embodiment, the ground model of the environment is generated via sensor data relating to the position of the ground via a plurality of sensor systems incorporated into a corresponding plurality of autonomous vehicles.

In one embodiment, the position of the object is determined by superimposing the virtual camera image onto the optical image data.

In one embodiment, the position of the object is determined by finding an intersection between the ground model in the virtual camera image and a geometric representation of the object.

In one embodiment, the geometric representation of the object is a bounding rectangle.

In one embodiment, the virtual camera image includes a plurality of pixels, each having a corresponding pre-computed distance from the vehicle and a point on the ground model.

In one embodiment, the ground model includes a two-dimensional array of position values in a world coordinate frame.

An autonomous vehicle in accordance with one embodiment includes at least one sensor that provides sensor data, the sensor data including optical image data acquired by an optical camera coupled to the vehicle. The autonomous vehicle further includes a controller that, by a processor and based on the sensor data, generates a virtual camera image based on a ground model, a position of the autonomous vehicle, and a position of the optical camera, and determines a position of an object in the environment based on the virtual camera image and the optical image data.

In accordance with one embodiment, the ground model of the environment is generated by acquiring sensor data relating to the position of the ground via a plurality of sensor systems incorporated into a corresponding plurality of autonomous vehicles.

In one embodiment, the position of the object is determined by superimposing the virtual camera image onto the optical image data and determining an intersection between the ground model in the virtual camera image and a geometric representation of the object.

In one embodiment, the geometric representation of the object is a bounding rectangle.

In one embodiment, the virtual camera image includes a plurality of pixels, each having a corresponding pre-computed distance from the vehicle and a point on the ground model.

In one embodiment, the ground model includes a two-dimensional array of position values relative to a world coordinate frame.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle including a visual position estimation system, in accordance with various embodiments;

FIG. 2 is a functional block diagram illustrating a transportation system having one or more autonomous vehicles as shown in FIG. 1, in accordance with various embodiments;

FIG. 3 is functional block diagram illustrating an autonomous driving system (ADS) associated with an autonomous vehicle, in accordance with various embodiments;

FIG. 4 is a dataflow diagram illustrating a visual position estimation system of an autonomous vehicle, in accordance with various embodiments;

FIG. 5 is a flowchart illustrating a control method for controlling the autonomous vehicle, in accordance with various embodiments;

FIG. 6 illustrates and example ground model, in accordance with various embodiments;

FIG. 7 illustrates an object detected by a camera incorporated into an autonomous vehicle, in accordance with various embodiments;

FIG. 8 illustrates a virtual camera field of view corresponding to the environment depicted in FIG. 7; and

FIG. 9 illustrates a combination of a virtual camera image and an actual camera image corresponding to the examples of FIGS. 7 and 8, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning models, radar, lidar, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

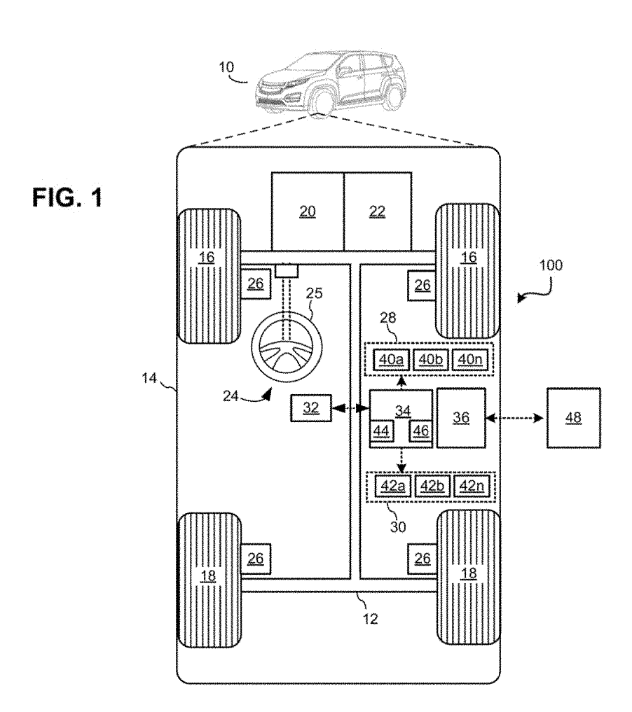

With reference to FIG. 1, a visual position estimation system shown generally as 100 is associated with a vehicle 10 in accordance with various embodiments. In general, visual position estimation system (or simply “system”) 100 allows for estimating the position of detected objects in the vicinity of AV 10 using a ground model and a virtual camera image based on the location and pose of AV 10.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the visual position estimation system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, etc., can also be used.

In an exemplary embodiment, the autonomous vehicle 10 corresponds to a level four or level five automation system under the Society of Automotive Engineers (SAE) “J3016” standard taxonomy of automated driving levels. Using this terminology, a level four system indicates “high automation,” referring to a driving mode in which the automated driving system performs all aspects of the dynamic driving task, even if a human driver does not respond appropriately to a request to intervene. A level five system, on the other hand, indicates “full automation,” referring to a driving mode in which the automated driving system performs all aspects of the dynamic driving task under all roadway and environmental conditions that can be managed by a human driver. It will be appreciated, however, the embodiments in accordance with the present subject matter are not limited to any particular taxonomy or rubric of automation categories. Furthermore, systems in accordance with the present embodiment may be used in conjunction with any vehicle in which the present subject matter may be implemented, regardless of its level of autonomy.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel 25 for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10 (such as the state of one or more occupants). Sensing devices 40a-40n might include, but are not limited to, radars (e.g., long-range, medium-range-short range), lidars, global positioning systems, optical cameras (e.g., forward facing, 360-degree, rear-facing, side-facing, stereo, etc.), thermal (e.g., infrared) cameras, ultrasonic sensors, odometry sensors (e.g., encoders) and/or other sensors that might be utilized in connection with systems and methods in accordance with the present subject matter.

The actuator system 30 includes one or more actuator devices 42a-42n that control one or more vehicle features such as, but not limited to, the propulsion system 20, the transmission system 22, the steering system 24, and the brake system 26. In various embodiments, autonomous vehicle 10 may also include interior and/or exterior vehicle features not illustrated in FIG. 1, such as various doors, a trunk, and cabin features such as air, music, lighting, touch-screen display components (such as those used in connection with navigation systems), and the like.

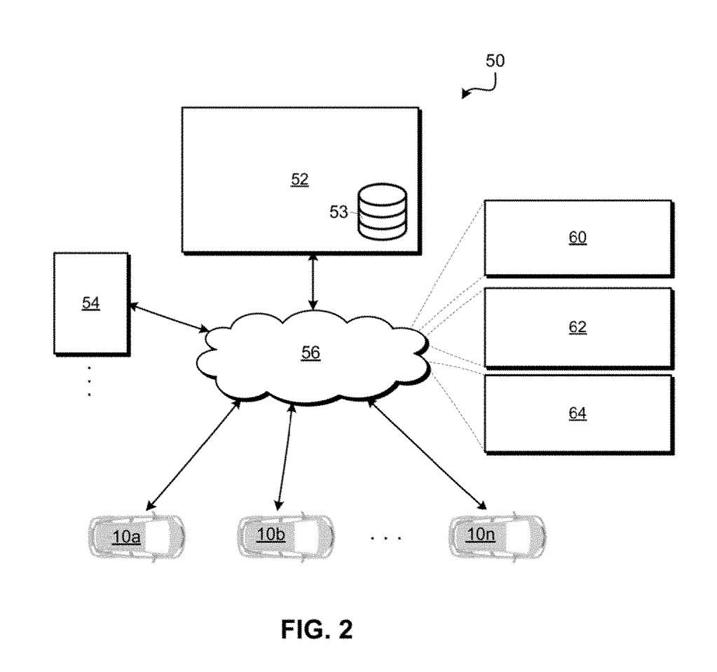

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. Route information may also be stored within data storage device 32—i.e., a set of road segments (associated geographically with one or more of the defined maps) that together define a route that the user may take to travel from a start location (e.g., the user's current location) to a target location. As will be appreciated, the data storage device 32 may be part of the controller 34, separate from the controller 34, or part of the controller 34 and part of a separate system.

The controller 34 includes at least one processor 44 and a computer-readable storage device or media 46. The processor 44 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10. In various embodiments, controller 34 is configured to implement a visual position estimation system as discussed in detail below.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals that are transmitted to the actuator system 30 to automatically control the components of the autonomous vehicle 10 based on the logic, calculations, methods, and/or algorithms. Although only one controller 34 is shown in FIG. 1, embodiments of the autonomous vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

The communication system 36 is configured to wirelessly communicate information to and from other entities 48, such as but not limited to, other vehicles (“V2V” communication), infrastructure (“V2I” communication), networks (“V2N” communication), pedestrian (“V2P” communication), remote transportation systems, and/or user devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous-vehicle-based remote transportation system. FIG. 2 illustrates an exemplary embodiment of an operating environment shown generally at 50 that includes an autonomous-vehicle-based remote transportation system (or simply “remote transportation system”) 52 that is associated with one or more autonomous vehicles 10a-10n as described with regard to FIG. 1. In various embodiments, the operating environment 50 (all or a part of which may correspond to entities 48 shown in FIG. 1) further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 may include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a component of a home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, not shown), which may be cloud-based, network-based, or resident at the particular campus or geographical location serviced by the remote transportation system 52. The remote transportation system 52 can be manned by a live advisor, an automated advisor, an artificial intelligence system, or a combination thereof. The remote transportation system 52 can communicate with the user devices 54 and the autonomous vehicles 10a-10n to schedule rides, dispatch autonomous vehicles 10a-10n, and the like. In various embodiments, the remote transportation system 52 stores store account information such as subscriber authentication information, vehicle identifiers, profile records, biometric data, behavioral patterns, and other pertinent subscriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

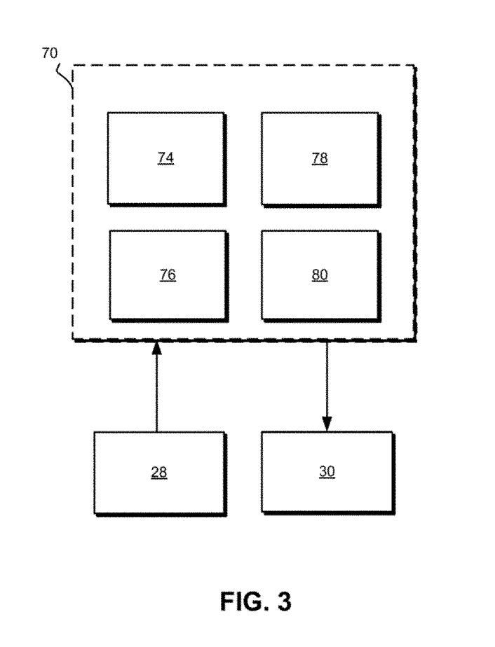

In accordance with various embodiments, controller 34 implements an autonomous driving system (ADS) 70 as shown in FIG. 3. That is, suitable software and/or hardware components of controller 34 (e.g., processor 44 and computer-readable storage device 46) are utilized to provide an autonomous driving system 70 that is used in conjunction with vehicle 10.

In various embodiments, the instructions of the autonomous driving system 70 may be organized by function or system. For example, as shown in FIG. 3, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors (e.g., sensor system 28), including but not limited to cameras, lidars, radars, and/or any number of other types of sensors.

The positioning system 76 processes sensor data along with other data to determine a position (e.g., a local position relative to a map, an exact position relative to a lane of a road, a vehicle heading, etc.) of the vehicle 10 relative to the environment. As can be appreciated, a variety of techniques may be employed to accomplish this localization, including, for example, simultaneous localization and mapping (SLAM), particle filters, Kalman filters, Bayesian filters, and the like.

The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

In various embodiments, all or parts of the visual position estimation system 100 may be included within the computer vision system 74, the positioning system 76, the guidance system 78, and/or the vehicle control system 80. As mentioned briefly above, the visual position estimation system 100 of FIG. 1 is configured to estimate the spatial position of one or more detected objects in the vicinity of AV 10 (e.g., vehicles, pedestrians, construction objects, or the like) by generating a virtual camera image of the environment based on a ground model, then superimposing the virtual camera image on an actual camera image acquired by AV 10. The position of the detected object can then be estimated based on where the detected object (e.g., a bounding rectangle of the detected object) intersects the ground model.

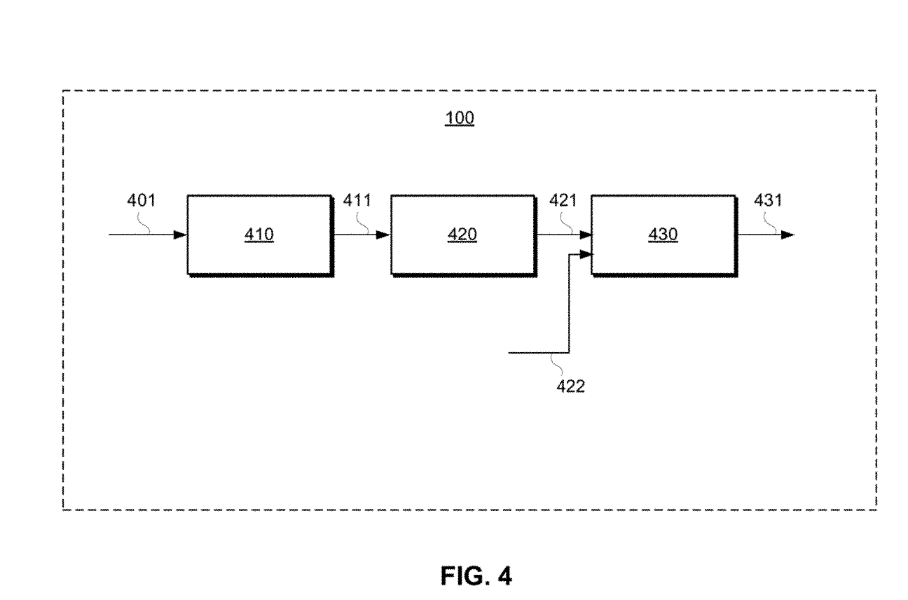

Referring now to FIG. 4, with continued reference to FIGS. 1-3, an exemplary visual position estimation system 100 in accordance with various embodiments includes a ground model creation module 410, a virtual camera image module 420, and an object position determination module 430. Ground model creation module 410 generally receives sensor data 401 relating to the vehicle's environment (e.g., camera images, lidar data, or any other sensor data received from sensors 28 of FIG. 1) and has, as its output (411) a ground model represented via any convenient data structure capable of characterizing the topography of the ground in the vicinity of AV 10. In one embodiment, as described in further detail below, ground model 411 is a mesh or matrix of points in three-dimensional space relative to a world coordinate frame.

Virtual camera image module 420 is generally configured to utilize the ground model 411 and generate a virtual camera image 421 corresponding to the expected ground topography in the vicinity of AV 10, given the actual location and pose of AV 10 (and its various sensors). That is, given the known location of AV 10 and the known positions of its various cameras, virtual camera image module 420 determines a projection of the ground model 411 within the field-of-view of the cameras (i.e., by placing the virtual camera in the same location and at the same orientation within the virtual space of ground model 411).

Object position determination module 430 is generally configured to receive the virtual camera image 421 and an actual camera image 422 and superimpose them in such a way that the spatial position (output 431) of detected objects (within the actual camera image 422) can be estimated. In one embodiment, as discussed in further detail below, the estimated position of a detected object is determined by examining the bounding rectangle of the detected object and determining where its lower edge or line segment intersects the ground model. The point or points of intersection within the ground model (whose positions in space are known) are then used to determine the estimated position of the detected object. It will be understood that the computational complexity of such an operation (e.g., determining the intersection of a rectangle and a mesh surface) is low, and hence estimating the location of objects in this way can be performed very quickly.

Various embodiments of the visual position estimation system 100 according to the present disclosure may include any number of sub-modules embedded within the controller 34 which may be combined and/or further partitioned to similarly implement systems and methods described herein. Furthermore, inputs to the visual position estimation system 100 may be received from the sensor system 28, received from other control modules (not shown) associated with the autonomous vehicle 10, received from the communication system 36, and/or determined/modeled by other sub-modules (not shown) within the controller 34. Furthermore, the inputs might also be subjected to preprocessing, such as sub-sampling, noise-reduction, normalization, feature-extraction, missing data reduction, and the like.

Furthermore, the various modules described above (e.g., modules 410, 420, and 430) may be implemented as one or more machine learning models that undergo supervised, unsupervised, semi-supervised, or reinforcement learning and perform classification (e.g., binary or multiclass classification), regression, clustering, dimensionality reduction, and/or such tasks. Examples of such models include, without limitation, artificial neural networks (ANN) (such as a recurrent neural networks (RNN) and convolutional neural network (CNN)), decision tree models (such as classification and regression trees (CART)), ensemble learning models (such as boosting, bootstrapped aggregation, gradient boosting machines, and random forests), Bayesian network models (e.g., naive Bayes), principal component analysis (PCA), support vector machines (SVM), clustering models (such as K-nearest-neighbor, K-means, expectation maximization, hierarchical clustering, etc.), linear discriminant analysis models. In some embodiments, training occurs within a system remote from vehicle 10 (e.g., system 52 in FIG. 2) and is subsequently downloaded to vehicle 10 for use during normal operation of vehicle 10. In other embodiments, training occurs at least in part within controller 34 of vehicle 10, itself, and the model is subsequently shared with external systems and/or other vehicles in a fleet (such as depicted in FIG. 2). Training data may similarly be generated by vehicle 10 or acquired externally, and may be partitioned into training sets, validation sets, and test sets prior to training.

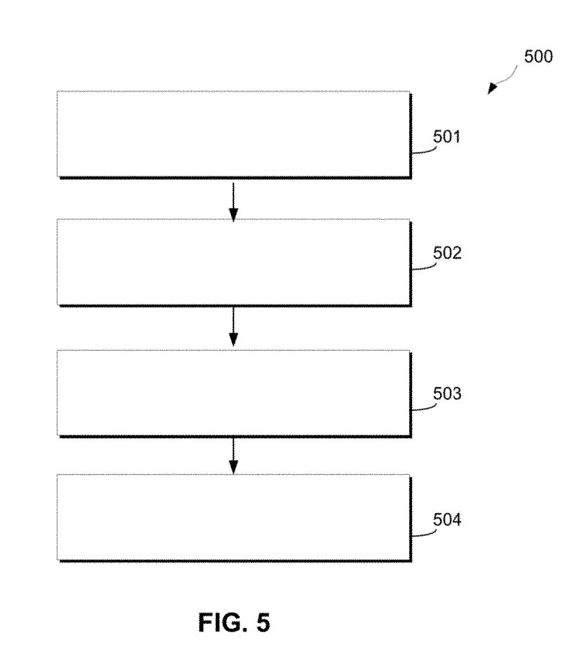

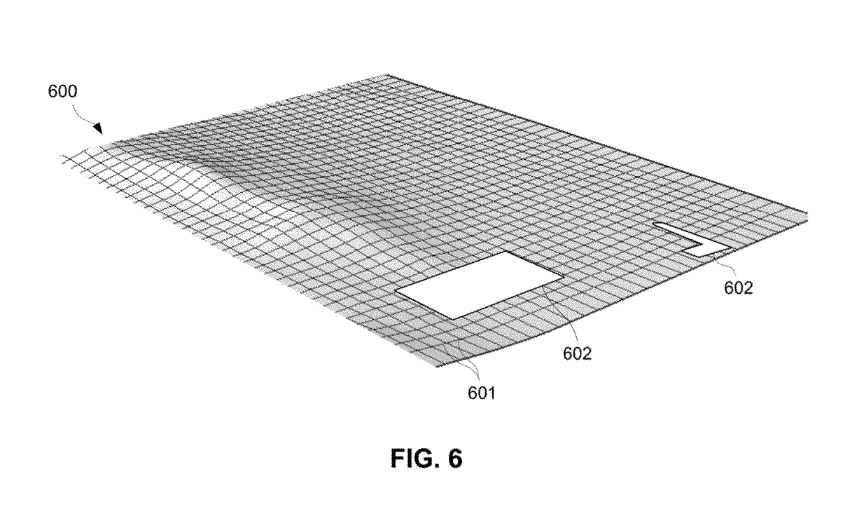

Referring now to FIG. 5 along with previously described FIGS. 1-4 and the various examples shown in FIGS. 6-9, the illustrated flowchart provides a control method 500 that can be performed by visual position estimation system 100 in accordance with the present disclosure. As can be appreciated in light of the disclosure, the order of operation within the method is not limited to the sequential execution as illustrated in the figure, but may be performed in one or more varying orders as applicable and in accordance with the present disclosure. In various embodiments, the method can be scheduled to run based on one or more predetermined events, and/or can run continuously during operation of autonomous vehicle 10.

In various embodiments, the method 500 begins at 501, in which a ground model of the environment is provided (e.g., by receiving the model from remote system 52. In that regard, FIG. 6 depicts an example ground model 600 that includes a mesh or matrix of points 601 that together characterize the topography of the “ground” (i.e., the nominal baseline surface corresponding to roadways, sidewalks, and other such surfaces typically observed by AV 10 during operation).

As will be appreciated, certain regions within ground model 600 might be undefined (illustrated as regions 602 in FIG. 6), since the position of the ground will not always be known, given the presence of buildings, trees, and other such structures. The presence of such undefined regions is not problematic, since ground model 600 is primarily directed at characterizing the roadways through which AV 10 is likely to travel.

The resolution (i.e., lateral spacing) of ground model 600 may vary, but in one embodiment ranges from about 0.5-1.5 meters. In some embodiments, the resolution of ground model 600 is on the order of 10-20 cm. While ground model 600 is illustrated as a square mesh, the range of embodiments are not so limited. Ground model 600 may be characterized by a mesh of rectangular elements, triangular elements, or any other convenient mesh element shape.

Regardless of the particular resolution used, ground model 600 includes a set of points having known absolute positions within a world coordinate frame (e.g., a 2D array of values corresponding to x, y, and z coordinates). As will be discussed below, these points can later be transformed into a camera 3D coordinate frame and then projected onto a 2D plane to produce a virtual image of the ground model 600.

Ground model 600 may be generated in a variety of ways. In one embodiment, for example, ground model 600 is generated by sensor data (e.g., lidar, radar, and optical data) acquired by multiple autonomous vehicles (such as AV 10) as they travel through the environment in the ordinary course of operation. That is, the ground model 600 may be populated and refined over time using sensor data acquired by a fleet of autonomous vehicles operating on the roadways over time. In one embodiment, only a predetermined region around the autonomous vehicle is used for characterizing the ground model 600—e.g., a 240×240 meter square region centered on the autonomous vehicle as it travels through the environment. In this way, AV 10 can avoid storing ground model information corresponding to regions through which AV 10 is not likely to travel (e.g., areas that are a significant distance away from any navigable space).

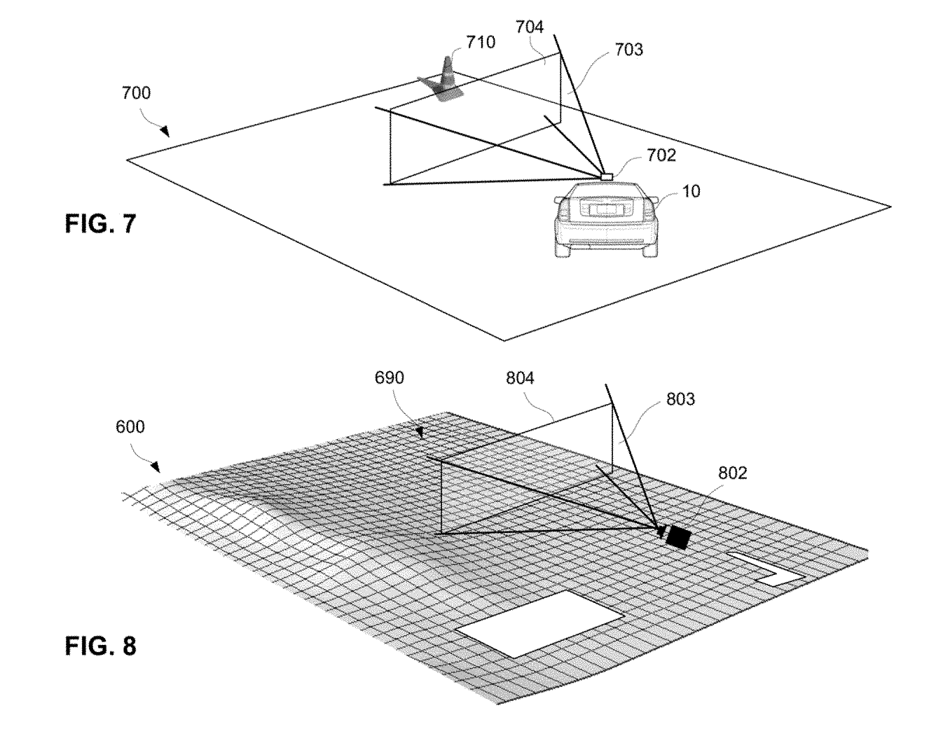

Referring again to FIG. 5, at 502 sensor data relating to the environment in the vicinity of AV 10 is received (e.g., via sensor system 28) during normal operation of AV 10. FIG. 7 illustrates an AV 10 that includes an optical camera 702 (illustrated, without loss of generality, as a top-mounted camera) whose position and orientation are such that it has a field-of-view 703. Camera 702 thus acquires an image of the environment 700 represented by rectangular region 704. As depicted in this example, an object 710 (illustrated as a traffic cone in the figure) is depicted by AV 10 using any available sensor data (such as optical, lidar, and radar data).

Given the known location of AV 10 as well the known position and orientation of camera 702 relative to AV 10, at 502 a virtual camera image of the ground model 600 is generated. This may performed at regular intervals, e.g., at a sampling rate of about 10 Hz. In this regard, FIG. 8 depicts a virtual camera 802 that is “placed” (within the virtual environment of ground model 600) at a virtual location that corresponds to the location and orientation of actual camera 702 of FIG. 7. As will be appreciated, the position of AV 10 as well as the position and orientation of camera 702 relative to AV 10 will be known a priori as a result of any calibration procedures carried out with respect to camera 702. Similarly, since the focal distance and other geometric characteristics of camera 702 are also known, virtual camera 802 can be configured such that it has a field-of-view 803 that is also substantially identical to field-of-view 703 of actual camera 702. In this way, a virtual image (804) of a region 690 of ground model 600 may be generated. In one embodiment, the virtual image 804 includes, at each pixel, a computed distance from virtual camera 802 to the corresponding mesh point of ground model 600.

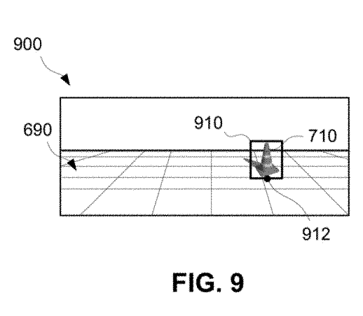

Finally, at 504, the position of the detected object 710 is estimated based on the virtual camera image 804 and the actual camera image 704. This may be accomplished in a variety of ways. By way of a non-limiting example, FIG. 9 depicts an image 900 corresponding to the superposition of virtual image 704 (of FIG. 7) and actual camera image 804 (of FIG. 8). The detected object 710 is shown along with its bounding rectangle 910. As can be seen, a bottom portion (e.g., the bottom-most line segment) of bounding rectangle 910 intersects ground model region 690 in the vicinity of a point 912. Since the position of point 912 within the ground model 600 is known, the position of detected object 710 can be estimated based on the position of point 912. Other methods that take into the account bounding rectangle 910 (or any other bounding shape) and its geometric relationship to ground model region 690 may be employed.

In some embodiments, the system includes an ability to also associate uncertainty in distance measurement based off of location. For example, if AV 10 observes a hill that gently away from it, the system will reduce its level of certainty with respect to vehicle locationing because there are multiple positions in the map space that correspond to the same pixel in the image space. However, if the vehicle is proceeding up a hill, AV 10 may have know the respective location with a high degree of confidence.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A visual position estimation method comprising:
providing a ground model of an environment;
receiving, at a vehicle, sensor data relating to the environment, the sensor data including optical image data acquired by an optical camera coupled to the vehicle;
generating, with a processor, a virtual camera image based on the ground model, the position of the vehicle, and a position of the optical camera; and
determining, with a processor, a position of an object in the environment based on the virtual camera image and the optical image data.

2. The method of claim 1, wherein providing the ground model of the environment includes acquiring sensor data relating to the position of the ground via a plurality of sensor systems incorporated into a corresponding plurality of autonomous vehicles.

3. The method of claim 1, wherein determining the position of the object includes superimposing the virtual camera image onto the optical image data.

4. The method of claim 3, wherein determining the position of the object includes determining an intersection between the ground model in the virtual camera image and a geometric representation of the object.

5. The method of claim 4, wherein the geometric representation of the object is a bounding rectangle.

6. The method of claim 1, wherein the virtual camera image includes a plurality of pixels, each having a corresponding pre-computed distance from the vehicle and a point on the ground model.

7. The method of claim 1, wherein the ground model includes a two-dimensional array of position values in a world coordinate frame.

8. A system for controlling a vehicle, comprising:
a ground model creation module, including a processor, configured to generate a ground model of an environment;
a sensor system configured to produce sensor data relating to the environment, the sensor data including optical image data acquired by an optical camera coupled to the vehicle;
a virtual camera image module, including a processor, configured to generate a virtual camera image based on the ground model, the position of the vehicle, and a position of the optical camera; and
an object position determination module, including a processor, configured to determine a position of an object in the environment based on the virtual camera image and the optical image data.

9. The system of claim 8, wherein the ground model of the environment is generated via sensor data relating to the position of the ground via a plurality of sensor systems incorporated into a corresponding plurality of autonomous vehicles.

10. The system of claim 8, wherein the position of the object is determined by superimposing the virtual camera image onto the optical image data.

11. The system of claim 10, wherein the position of the object is determined by finding an intersection between the ground model in the virtual camera image and a geometric representation of the object.

12. The system of claim 11, wherein the geometric representation of the object is a bounding rectangle.

13. The system of claim 8, wherein the virtual camera image includes a plurality of pixels, each having a corresponding pre-computed distance from the vehicle and a point on the ground model.

14. The system of claim 8, wherein the ground model includes a two-dimensional array of position values in a world coordinate frame.

15. An autonomous vehicle, comprising:
at least one sensor that provides sensor data, the sensor data including optical image data acquired by an optical camera coupled to the vehicle, and a controller that, by a processor and based on the sensor data:
generates a virtual camera image based on a ground model, a position of the autonomous vehicle, and a position of the optical camera; and
determines a position of an object in the environment based on the virtual camera image and the optical image data.

16. The autonomous vehicle of claim 15, wherein the ground model of the environment is generated by acquiring sensor data relating to the position of the ground via a plurality of sensor systems incorporated into a corresponding plurality of autonomous vehicles.

17. The autonomous vehicle of claim 15, wherein determining the position of the object includes superimposing the virtual camera image onto the optical image data and determining an intersection between the ground model in the virtual camera image and a geometric representation of the object.

18. The autonomous vehicle of claim 17, wherein the geometric representation of the object is a bounding rectangle.

19. The autonomous vehicle of claim 15, wherein the virtual camera image includes a plurality of pixels, each having a corresponding pre-computed distance from the vehicle and a point on the ground model.

20. The autonomous vehicle of claim 15, wherein the ground model includes a two-dimensional array of position values in a world coordinate frame.
